(19) United States
(12) Patent Application Publication
(10) Pub. No.: US 2002/0170883 A1
(43) Pub. Date: Nov. 21, 2002

(54) Method of use for reusable monitor wafer

(76) Inventor: Ching-Yu Chang, Yuan-Shan Hsiang (TW)

Correspondence Address: NAIPO (NORTH AMERICA INTERNATIONAL PATENT OFFICE), P.O. BOX 506, MERRIFIELD, VA, 22116, US

(21) Appl. No.: 09/858,513

(22) Filed: May 17, 2001

(51) Int. Cl. C03C 25/68; C23F 1/00; C03C 15/00

(52) U.S. Cl. 216/108; 216/2; 216/95; 216/98

(57) ABSTRACT

A method of use for a reusable monitor wafer, having multiple crystal original pits (COP) on its surface, used for monitoring and measuring particle amounts in a chemical vapor deposition (CVD) process. First, a silicon oxide layer is formed on the surface of a monitor wafer. A first cleaning process and a thin film deposition process, forming a thin film layer on a surface of the silicon oxide layer, are then performed, respectively. Thereafter, a particle measurement process is performed to measure particle amounts on the surface of the thin film layer. After removing the thin film layer and the silicon oxide layer on the monitor wafer, respectively, a second cleaning process is performed.

### BACKGROUND OF THE INVENTION

1. Field of the Invention

The present invention relates to a method of use for a reusable monitor wafer, and more specifically, to a method of use for a reusable monitor wafer that prevents crystal original pits (COP) effects during particle measurement.

2. Description of the Prior Art

In a chemical vapor deposition (CVD) process, particles are normally found on the surface of a product due to peeled film in the chamber, impure reacting gases, improper operation parameters, contamination in cleaning processes, or impurity of the semiconductor itself. Because the quality of the product is influenced by the particles on the surface of the product, it is very important to reduce noise during particle measurement so as to obtain precise measuring results and thereby improve product yield rate.

Monitor wafers are commonly used to monitor particle amounts on the product surface to enhance the reliability of product quality. However, as the development of integrated circuits grows more complex and precise, monitored particles become smaller as well. Frequently, background noises caused by crystal original pits (COP) on the monitor wafer lead to difficulties in quality control when monitoring particles smaller than 0.3 microns. Additionally, monitor wafers currently used are not reusable, increasing production cost.

Please refer to FIG. 1 to FIG. 4. FIG. 1 through FIG. 4 are schematic views of using a monitor wafer 10 to measure particle amounts on the surface of the product according to the prior art. As shown in FIG. 1, the monitor wafer 10 is a silicon wafer 11 with multiple crystal original pits (COP) 12 and multiple particles 14. As shown in FIG. 2, a method of using the monitor wafer 10 to measure particle amounts according to the prior art begins by performing a thermal oxidation process, under room pressure and with an operational temperature ranging from 500° C. to 1000° C., on the surface of the monitor wafer 10. A silicon oxide layer 13, having a thickness ranging from 500 to 1000 angstroms, is thus formed to prevent acid etches on silicon portions of the monitor wafer 10 in the subsequent recycling process. As a result of the expansion of portions of silicon oxide around the COP 12, multiple nodules 16, having diameters ranging from 0.1 to 0.2 microns, are formed on the surface of the monitor wafer 10.

As shown in FIG. 3, a cleaning process, using standard cleaning solution (SC-1), is performed to remove the particles 14 on the surface of the monitor wafer 10 to complete the pretreatment process of the monitor wafer 10. As shown in FIG. 4, a CVD process is then performed to form a thin film 15 on the surface of the monitor wafer 10. Normally, particles appear and reside on the surface of the thin film 15 during the CVD process due to the reasons previously mentioned. Additionally, multiple nodules 18, having diameters ranging from 0.2 to 0.3 angstroms, are formed due to portions of the thin film 15 covering the nodules 16.

Finally, a particle measurement process is performed to measure the amounts of particles 19 on the surface of the thin film 15. However, the nodules 18 are frequently misjudged as particles, causing a discrepancy between the calculated value and the actual value of the noise background. As the size limitation for the particles measured becomes more and more rigid, the nodules 18 increasingly lead to miscalculation of the particle amounts on the surfaces of either the monitor wafer 10 or the product. Additionally, the monitor wafer 10 in the particle measurement process according to the prior art is not reusable.

### SUMMARY OF THE INVENTION

It is therefore a primary objective of the present invention to provide a method of use for a reusable monitor wafer that prevents crystal original pits (COP) effects on particle measurement, and reduces production costs.

In the present invention, the monitor wafer is a silicon wafer having multiple crystal original pits on its surface. A silicon oxide layer, having a predetermined thickness, is formed on the surface of the monitor wafer by performing a thermal oxidation process that oxidizes portions of the silicon wafer surface to prevent COP effects in a subsequent particle measurement process. A first cleaning process is then performed. By performing a thin film deposition process, a thin film layer is formed on the surface of the silicon oxide layer. The particle measurement process is then performed to measure particle amounts on the surface of the thin film layer. After removing the thin film layer and the silicon oxide layer on the monitor wafer, respectively, a second cleaning process is performed.

It is an advantage of the present invention that the silicon oxide layer is formed with a predetermined thickness. Thus the noise, caused by COP effects, in the particle measurement process can be prevented. Additionally, the monitor wafer is reusable after removing the thin film layer and the silicon oxide layer, respectively, and performing a second cleaning process on the monitor wafer. This significantly reduces production costs.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWING

FIG. 1 to FIG. 4 are schematic views of using a monitor wafer 10 to measure particle amounts on the surface of a product according to the prior art.

FIG. 5(a) to FIG. 5(d) are the schematic views of changing of multiple crystal original pits when forming silicon oxide layers of different thickness on a monitor wafer.

FIG. 6 to FIG. 11 are the schematic views of the method of use for a reusable monitor wafer 30 according to the present invention.

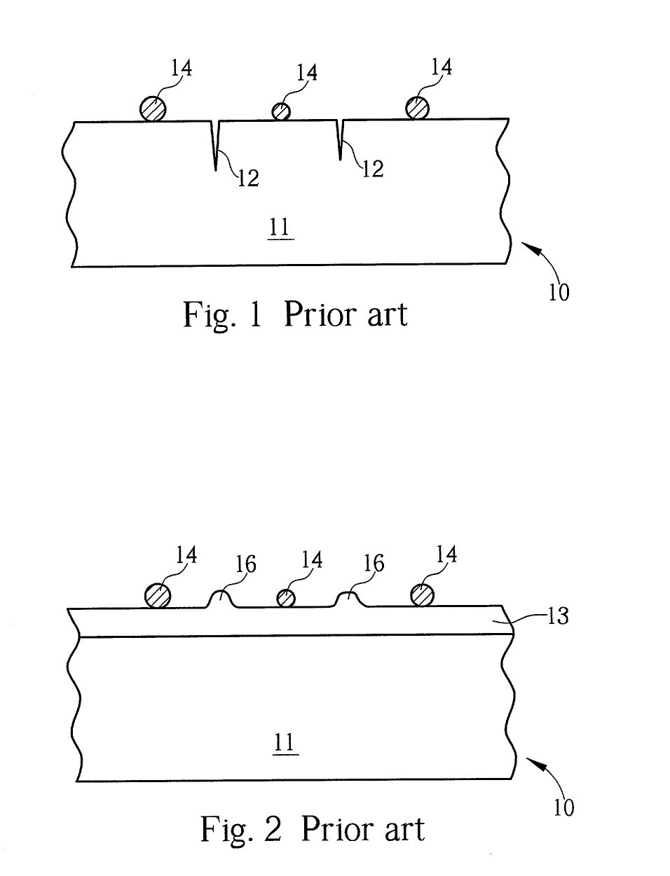

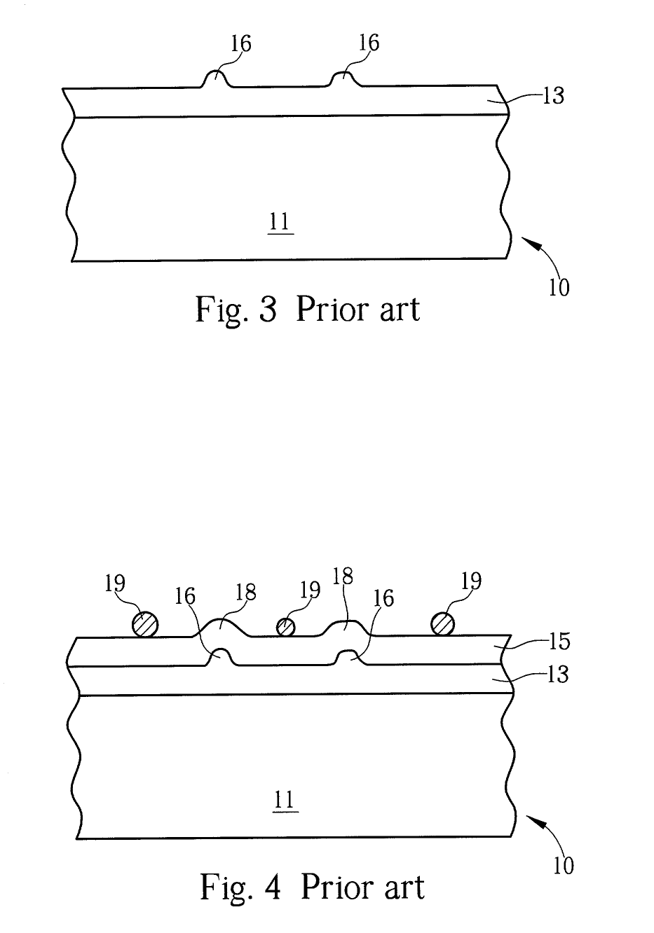

### DETAILED DESCRIPTION OF THE PREFERRED EMBODIMENT

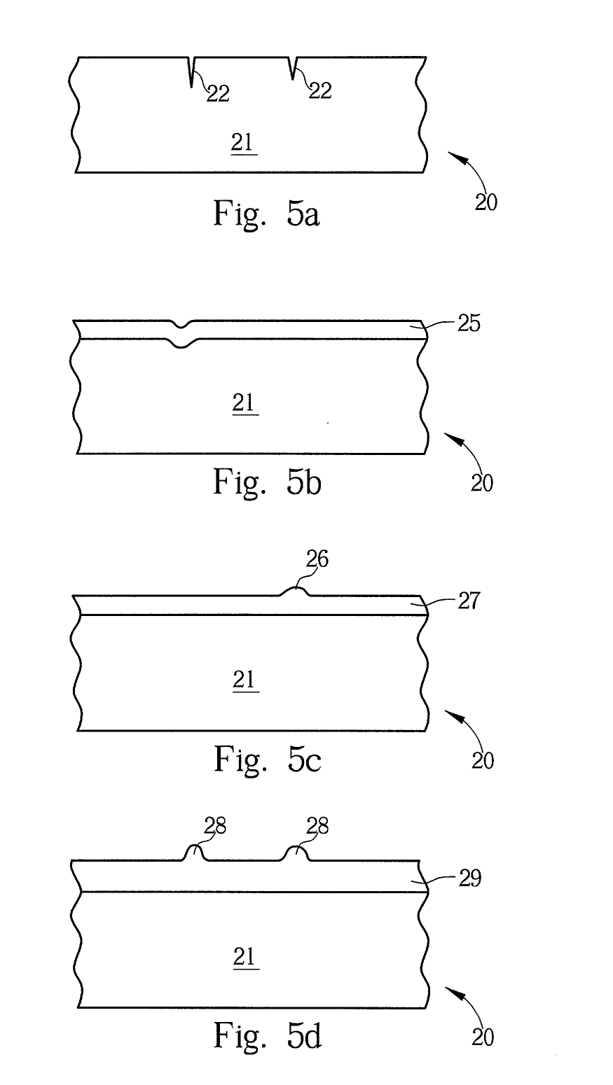

Please refer to FIG. 5(a) to FIG. 5(d). These figures are schematic views of changing of multiple crystal original pits (COP) during the formation of silicon oxide layers 25, 27 and 29, each having different thickness, on a monitor wafer 20, according to the present invention. As shown in FIG. 5(a), the monitor wafer 20 is a silicon wafer 21 with multiple crystal original pits on its surface. As shown in FIG. 5(b), a silicon oxide layer 25, having a thickness of 100 angstroms, is formed on the surface of the monitor wafer 20 by performing an oxidation process. Portions of silicon on the surface of the silicon wafer 21 expand due to the oxidation process, so that the crystal original pit 22 reduces, or even vanishes. However, no significant nodule is formed. As shown in FIG. 5(c), a silicon oxide layer 27, having a thickness of 300 angstroms, is formed on the surface of the monitor wafer 20. Portions of silicon on the surface of the silicon wafer 21 expand to form multiple tiny nodules 26 on the surface of the monitor wafer 20. As shown in FIG. 5(d), a silicon oxide layer 29, having a thickness greater than 500 angstroms, is formed on the surface of the monitor wafer 20. Simultaneously, multiple nodules 28, leading to noise in the subsequent particle measurement process, are formed on the surface of the monitor wafer 20. The silicon oxide layer 25 with a predetermined thickness can prevent noise, caused by COP effects, in the subsequent particle measurement process.

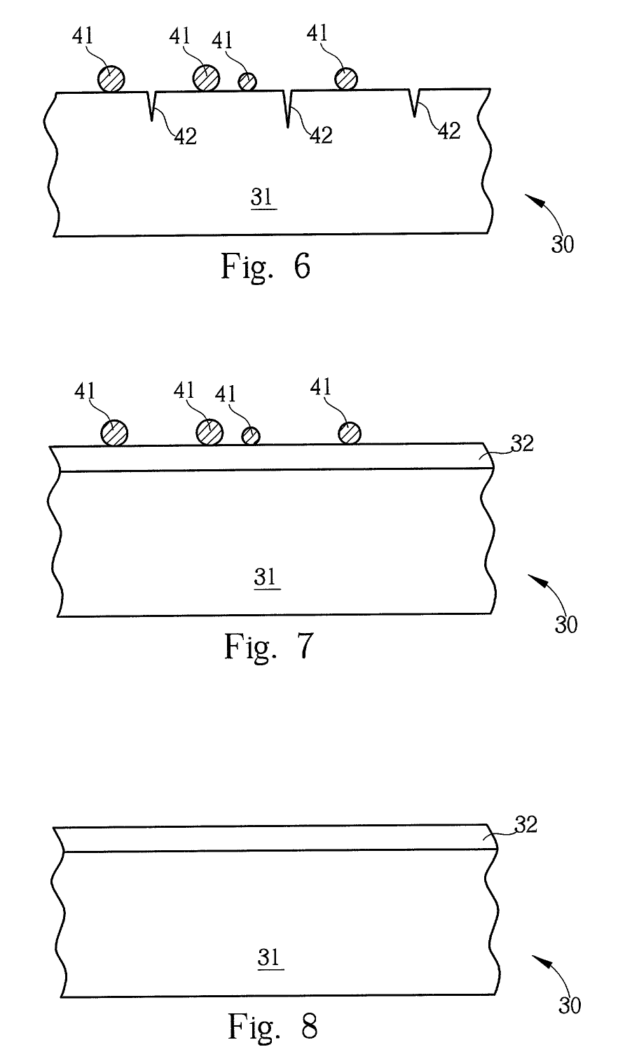

Please refer to FIG. 6 to FIG. 11. These figures are schematic views of the method of use for a reusable monitor wafer 30 according to the present invention. As shown in FIG. 6, the monitor wafer 30, used during a chemical vapor deposition (CVD) process to monitor and measure the amounts of particles generated in the CVD process, is a silicon wafer 31 with multiple crystal original pits 42 and multiple particles 41 on its surface. As shown in FIG. 7, a thermal oxidation process is performed, forming a silicon oxide layer 32 with an approximate thickness of 100 angstroms, so as to prevent COP effects on a subsequent particle measurement process. As shown in FIG. 8, a first cleaning process, using standard cleaning solution (SC-1) , is performed to remove particles 41 on the surface of the monitor wafer 30 so as to complete the pretreatment process on the monitor wafer 30. The formation of the silicon oxide layer 32 has the following two advantages:

(1) Particles are simultaneously oxidized to form an oxide film, which can be easily removed in the subsequent cleaning process, as the silicon oxide layer 32 is formed.

(2) The silicon oxide layer 32 is used as a protective layer to prevent acid etches on the silicon wafer 31 in the subsequent recycling process. As a result of the expansion of the surface portions of the silicon wafer 31 due to the thermal oxidation process, the crystal original pits 42 are filled by portions of the expanded silicon oxide layer 32 so as to form a flat surface on the monitor wafer 30. The thickness of the silicon oxide layer 32 ranging from 60 to 300 angstroms further avoids imprecise measuring results caused by COP effects in the particle measurement process.

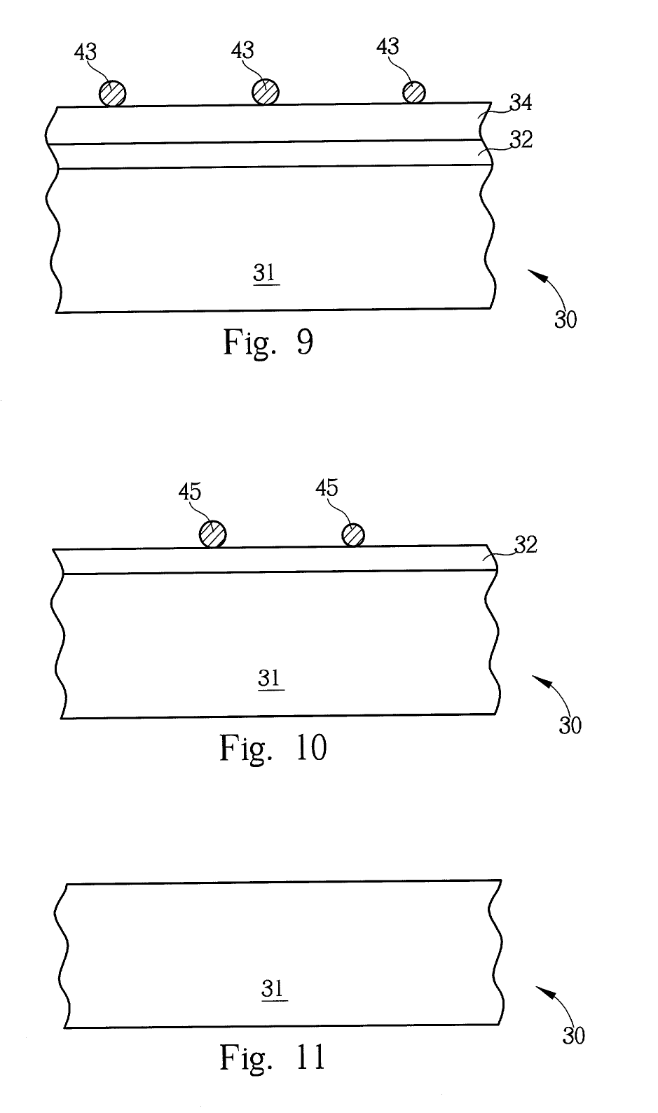

As shown in FIG. 9, a CVD process is then performed to form a thin film layer 34, composed of polysilicon, on the surface of the monitor wafer 30. Alternatively, the thin film layer 34 may be composed of tungsten silicide (WSiₓ), titanium nitride (TiN), tungsten (W) titanium silicide (TiSi), aluminum (Al), or copper (Cu). Simultaneously, multiple particles 43 are formed on the surface of the thin film layer 34 due to the CVD process. A particle measurement process is performed thereafter to measure the amount of particles 43 on the thin film layer 34. Without nodules, caused by the crystal original pits 42, on the surface of the monitor wafer 30, the noise background in the particle measurement process is significantly reduced, increasing the reliability of measuring results.

As shown in FIG. 10, the thin film layer 34 is then removed. For an embodiment using a thin film layer 34 composed of polysilicon, the polysilicon thin film layer 34 can be removed by performing a spin etching process or a wet bench etching process, as shown in the following equation (unbalanced):

Si+HNO₃ [symbol] SiO₂+NO+NO₂+. . . SiO₂+HF [symbol] H₂SiF₆

The spin etching process is performed by spraying a mixture gas, comprising nitric acid (HNO₃) and hydrofluoric acid (HF) in a proportion of 10:1, on the surface of the spinning monitor wafer 30. First, the nitric acid rapidly reacts with the polysilicon to form silicon oxide and oxy-nitride. Simultaneously, the hydrofluoric acid reacts with the silicon oxide to form fluosilicic acid (H₂SiF₆) at an approximate rate of 5000 Å/2 sec, so as to remove the thin film layer 34 completely. Alternatively, the wet bench etching process, normally leading to an over-etch on both the silicon oxide layer 32 and the silicon wafer 31, can be performed to remove the thin film layer 34 previously formed on the surface of the silicon wafer 31 by the CVD process, used to form the thicker silicon oxide layer 32, so as to prevent damage on the surface of the silicon wafer 31.

As shown in FIG. 11, a 49% (w/w) HF solution is employed to remove the silicon oxide layer 32 and residual particles 45 on the surface of the silicon oxide layer 32 after removing the thin film layer 34. Finally, a second cleaning process, using SC-1, is performed to complete the method of the present invention.

In the preferred embodiment of the present invention, the monitor wafer is a silicon wafer 31 with multiple crystal original pits 42 on its surface. More crystal original pits can be induced and formed on the surface of the constantly reused monitor wafer 30, leading to imprecise results of the particle measurement process. Therefore, a pretreatment is performed to form a silicon oxide layer 32 on the surface of the monitor wafer 30, as well as to perform a first cleaning process on the surface of the monitor wafer that uses SC-1 as the cleaning solution. After pretreatment, the monitor wafer 30 is placed with other semiconductor wafers in subsequent CVD processes, including the CVD process performed to form a thin film layer 34 composed of polysilicon. The amount of particles 43 is then measured by performing a particle measurement process. A spin etching process and a strong HF solution are employed to remove the polysilicon thin film layer 34 and the silicon oxide layer 32, respectively, on the surface of the monitor wafer 30. A second cleaning process is performed at the end of the method provided in the present invention so as to recycle the monitor wafer 30.

In contrast with the prior art, the multiple crystal original pits 42 on the surface of the monitor 30 are filled with the silicon oxide layer 32, having a thickness less than 500 Å in the present invention. Therefore, nodules on the surface of the monitor wafer 30 that lead to increased noise background in the particle measurement process can be prevented. Additionally, a spin etching process and a strong HF solution are employed to remove the polysilicon thin film layer 34 and the silicon oxide layer 32, respectively, on the surface of the monitor wafer 30. The monitor wafer 30 can then be recycled.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A method of use for a reusable monitor wafer, the monitor wafer used for monitoring and measuring particle amounts in a thin film deposition process, the method comprising:
forming a silicon oxide layer on a surface of the monitor wafer;
performing a first cleaning process;
performing a thin film deposition process to form a thin film layer on a surface of the silicon oxide layer;
performing a particle measurement process to measure particle amounts on the surface of the thin film layer;
removing the thin film layer on the monitor wafer;
removing the silicon oxide layer on the surface of the monitor wafer; and
performing a second cleaning process.

2. The method of claim 1 wherein the monitor wafer is a silicon wafer with multiple crystal original pits (COP) on a top surface.

3. The method of claim 2 wherein the silicon oxide layer is formed on the surface of the silicon wafer by performing a thermal oxidation process, the silicon oxide layer having a thickness of less than 500 angstroms.

4. The method of claim 3 wherein the the thickness of the silicon oxide layer ranges from 60 to 300 angstroms, and avoids effects caused by the crystal original pits in the particle measurement process.

5. The method of claim 1 wherein the silicon oxide layer is formed by performing a chemical vapor deposition (CVD) process.

6. The method of claim 1 wherein the thin film deposition process is a CVD process.

7. The method of claim 6 wherein the thin film comprises polysilicon, silicon nitride (Si₃N₄), tungsten silicide (WSiₓ), titanium nitride (TiN), tungsten (W) titanium silicide (TiSi), aluminum (Al), or copper (Cu).

8. The method of claim 1 wherein the silicon oxide layer on the surface of the monitor wafer is removed by a strong acid solution.

9. The method of claim 8 wherein the strong acid solution is a 49% (w/w) hydrofluoric acid (HF) solution.

10. The method of claim 1 wherein both a cleaning solution in the first cleaning process and a cleaning solution in the second cleaning process comprise a standard cleaning solution (SC-1).
